(19) United States
(12) Patent Application Publication
(10) Pub. No.: US 2012/0074157 A1
(43) Pub. Date: Mar. 29, 2012

(54) CLOSURE ASSEMBLY

(75) Inventor: Paul Robert Dunwoody, Oxfordshire (GB)

(73) Assignee: CROWN PACKAGING TECHNOLOGY, INC., Alsip, IL (US)

(21) Appl. No.: 13/375,090

(22) PCT Filed: May 24, 2010
(86) PCT No.: PCT/EP2010/057086

§ 371 Date: Nov. 29, 2011

(30) Foreign Application Priority Data
May 29, 2009 (GB) 0909189.3

(51) Int. Cl. B65D 51/14; B23P 19/00

(52) U.S. Cl. 220/780; 29/428

(57) ABSTRACT

A closure assembly comprising a two-part closure having a metal panel or disc (2) and a ring (3), and a container such as a glass jar (20). The ring (3) is substantially cylindrical with an axially upwardly extending sidewall and has a radially inwardly extending lower edge. The jar (20) terminates in a radially outwardly extending beaded rim (16) and the disc (2) has a curled circumference (8) such that this curl (8) co-operates with the beaded rim (16) of the container to provide a primary seal. In one example, in a metal ring (3), the lower edge is curled with equally spaced lugs (13) on the skirt wall. In a plastic ring, the upper rim feature may be omitted.

### TECHNICAL FIELD

This invention relates to a closure assembly and also to a closure for use in such an assembly. The closure assembly comprises a container, which usually includes an engagement feature such as threads, and a closure. The closure is a two-part type of closure, which comprises an inner cap or disc part, and a ring or skirt part.

Typically the closure is used with a container for packaging food stuffs such as pickles, tomato based products, fruit juice or baby food. Such a closure is often referred to as a lid or cap and engages or disengages with the container for closing or opening respectively. In one aspect the invention also relates to a sub-assembly of the threaded container and the ring part of the closure.

### BACKGROUND ART

Known two-part closures comprise a cap or disc which is held onto a container by a skirt, which is sometimes referred to as a ring, or by an overcap. The two parts may be of the same material, or different materials as in a combination closure or “combo-cap” which uses a metal disc and a plastic skirt. The skirt often defines threads or lugs, which cooperate with complementary features on a container neck. Sealing material is conventionally applied to the disc to form a seal between the disc and the mouth of the container.

There are many examples of two-part closures, of which U.S. Pat. No. 3,466,381 A (PODESTA ET AL) is one of the older examples. That patent describes a two-part metallic cap with a separate disc and “sleeve-like” skirt. Another two-piece metallic cap from the same inventor is shown in U.S. Pat. No. 3,836,033 A (PODESTA). The metallic disc in that patent moves between concave and convex configurations. Both of these closures can be used for containers such as glass bottles, pots and the like.

It has also been popular to provide screw threads or lugs on the skirt, whether this is of metal or of plastics material. For example, the skirt may be part of a threaded outer cap, as in U.S. Pat. No. 4,473,163 B (ERNST) in which the outer cap prises the inner cap off the container during unscrewing. This is particularly useful when the closure is used for the packaging of food products, which during processing “pull” a negative pressure, often called a “vacuum”. This vacuum creates a substantial resistance to opening. The two-piece cap of EP 1686070 A (PLATO PRODUCT CONSULTANTS V.O.F.) has a special feature to reduce torque on opening. This feature is similar to a dimple, which during opening, pushes up a disc-shaped inner cap to overcome the forces between jar and closure, which create the sealing of the package.

The 2-piece closure design allows the breaking of the container seal to be controlled. The initial twisting of the skirt is sometimes used to activate a tamper-evident feature, such as breaking a tamper-evident band, whilst the disc remains sealed to the container. Thereafter, a further feature may be provided on the skirt to prise the disc from the container, thereby breaking the seal between the disc and the container to equalise any difference between the internal pressure in the container and the external environment. This 2-stage opening reduces the torque required to open the closure and allows the closure to be removed more easily.

Although known features such as those described above can reduce the force necessary to break vacuum, there are still problems inherent in the combined opening force requirements of unscrewing and breaking the vacuum. This invention seeks to overcome those problems.

### DISCLOSURE OF INVENTION

According to the present invention, there is provided a two-part closure having a metal panel or disc and a ring or “skirt” and being adapted for use with a container (20), in which: the ring or skirt comprises a radially inwardly extending pry-off feature on a substantially cylindrical sidewall; and the metal panel or disc comprises a centre panel, a shoulder and a feature, which is typically a snap-fit feature, for engaging with the rim of the container to form a seal.

The ring part of a closure of this type of assembly may be applied to the container before the container is closed using the panel part. Likewise, it may not be necessary to remove the ring completely or with the panel in order to open the container and remove its contents.

Preferably, the pry-off feature comprises continuous or discontinuous circumferential beads or lugs, which may also be arranged to engage with helical features on the sidewall of the container for rotating of the ring on the sidewall.

The pry-off feature on the closure ring or skirt may be adapted to release the metal panel or disc by breaking the seal between the panel feature and the container edge.

The feature on the panel may comprise a radially inwardly curled edge, which co-operates with the rim of the container as a snap-fit feature. The curled edge is preferably in the range of 0.4-1.0 mm radius. The alternative term to panel which is used herein, i.e. “disc”, is used to define the whole of an inner cap component and is not intended to infer that that component is simply a thin circular component. The disc may be profiled for sealing a container to which the closure is attached.

Preferably, the container includes a bead and the panel's curled edge, in use, fits over the bead. The container bead assists retention of the panel part. The curled edge of the panel may be an inward or an outward curl, and may include undulations and/or pleats.

The container may be a jar or bottle (of glass or plastics material) or even a metal can, and although a usual use for the closure of the invention would be with a glass jar used for packaging foodstuffs, the expressions are used interchangeably in this application.

The two parts of the closure may be provided separately, and the ring or skirt part assembled to the container as a sub-assembly. Clearly when the ring is pre-assembled to the container, it must be profiled such that the panel can close the container in a separate subsequent operation. For this sub-assembly, the ring does not have an inwardly projecting rim.

An advantage of the ring of the present invention is that there is no need to rotate any part of the closure or jar during capping, provided that the ring is positioned with its lugs below the jar thread. Simpler and more reliable high-speed capping than that of conventional twist closures can thus be achieved. The ring may also be easily removed from the jar after use to assist recycling.

Another alternative ring may be provided that has an inwardly projecting lower rim. This lower rim may be used to retain the ring on the jar, which is especially useful if the ring is to be applied to the jar before it is filled and closed using the panel part. The shape and flexibility of the ring is adjustable to allow the ring to be removed from the jar to assist recycling.

This ring may be made of either metal or plastic material, and the outer surfaces may be knurled or shaped to assist grip by consumers for ease of opening. The use of this type of ring also permits the consumer to more easily re-close the container by simply pushing the panel down onto the jar, without need for twisting.

In a further aspect of the invention, which provides a method of attaching the ring to the container or jar, filling the container/jar and closing the container/jar with the panel, the method could involve providing the sub-assembly to the filler who would then fill the container/jar and add the panel prior to processing.

The sidewall of the ring may extend axially and vertically beyond the disc whereby, in use, the disc is protected.

The pry-off feature may be situated at a distance from the top edge of the ring and, most importantly, spaced from the snap-fit feature of the disc when, in use, the closure is in its closed position on a container.

In a preferred embodiment, the metal panel comprises DR (double reduced tinplate or ECCS in the range of 500-600 Nmm⁻² and thickness ranging between 0.13 mm and 0.2 mm. The material is normally selected to provide suitable panel strength when subjected to pressure and vacuum during and after food processing. When the ring is of metal, the ranges may be the same as for the panels.

### BRIEF DESCRIPTION OF FIGURES IN THE DRAWINGS

Preferred embodiments of the invention will now be described, by way of example only, with reference to the drawings, in which:

FIGS. 1A and 1B are partial side sections of an all-metal closure with an annular projection on the wall of its skirt;

FIG. 2 is a partial side section through a curl of a closure with plain wall;

FIG. 3 is a partial side section through a lug of the closure of FIG. 2;

FIG. 4 is an underplan view showing four lugs;

FIG. 5 is a partial side section through a curl of an alternative closure with an outward disc curl;

FIG. 6 is the partial side section of FIG. 5 through a lug of the closure;

FIG. 7 is a partial side section through the curl of the closure of FIGS. 2 and 3 in closed position on a jar;

FIG. 8 is a partial side section through a lug of the closure of FIGS. 2 and 3 in closed position on a jar;

FIG. 9 is a partial side section through the curl of the closure of FIGS. 2 and 3, above a jar after opening;

FIG. 10 a partial side section through a lug of the closure of FIGS. 2 and 3, above a jar after opening;

FIG. 11 is a partial side section through a curl of a closure with an outward curl on the disc;

FIG. 12 is a partial side section through a curl of a closure, with the top of the ring above the disc;

FIG. 13 is a partial side section through a lug of the closure of FIG. 12;

FIGS. 14a and 14b are perspective views of a closure ring and closure with four inwardly projecting rim portions opposite gaps between lugs;

FIG. 15 is a perspective view of a disc having flats;

FIG. 16 is a perspective view of the disc of FIG. 15, fitted in a ring.

FIGS. 17a to f are views of an alternative ring and a closed jar and sectional views of a jar and closure with the ring;

FIGS. 18a to f are views of a further alternative ring and a closed jar and sectional views of a jar and closure with the ring;

FIG. 19 is a cross section similar to that of FIG. 17 with a ring made of metal; and

FIG. 20 is a cross section similar to that of FIG. 18 with a ring made of metal.

### MODE(S) FOR CARRYING OUT THE INVENTION

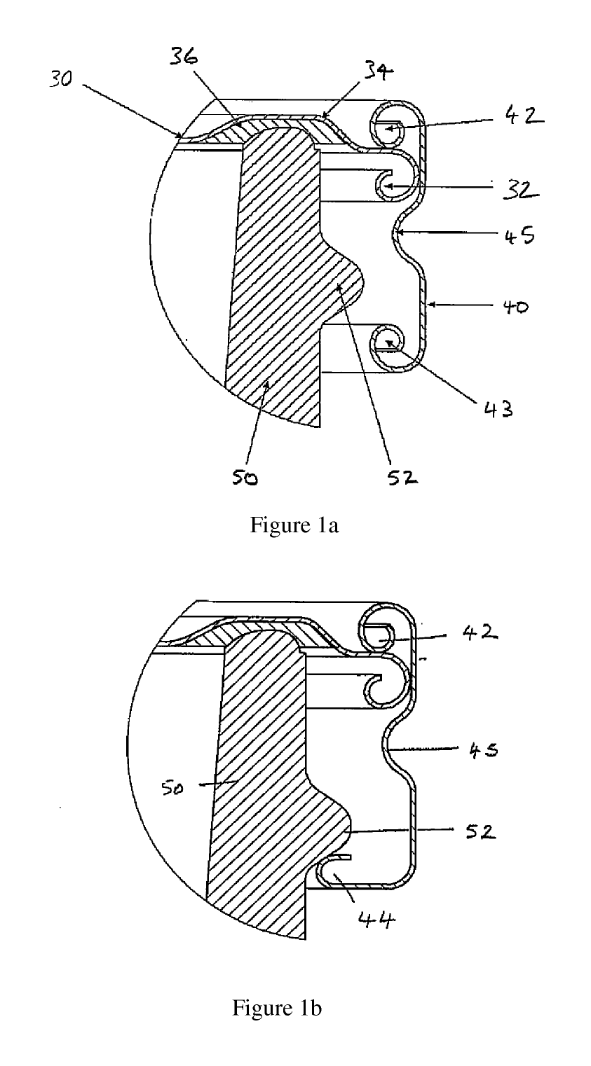

FIGS. 1A and 1B are side sections of a two-part closure manufactured for example in accordance with unpublished patent application PCT/EP2007/061744. Alternatively, the ring could be manufactured separately by techniques such as welding (e.g. laser welding), extrusion, or by using tubing. This of course means that the ring is not necessarily formed from metal. The closure comprises a metal disc 30, having its cut edge protected by a curl 32, and a circumferential ring 40. The disc 30 is trapped within the ring 40 by two curls 42, 43 at the opposed axial ends of the ring. FIG. 1A is a section through a curl 43 and FIG. 1B is a section through a lug 44.

A retention feature, or features 45 is/are provided to position the disc 30 loosely within the ring 40, whilst allowing the disc 30 freedom to move rotationally relative to the ring 40 and limiting axial movement. The retention feature 45 may take the form of spaced projections around the circumference of the ring 40, or alternatively may be provided by a circumferential bead, either full or segmented. A channel 34 is provided about the inside periphery of the disc 30 and this channel is used to hold sealing material 36. The provision of the channel 34 ensures proper location of the sealing material to interface with the neck of a container 50 and also reduces the quantity of sealing material 36 because of its better and more accurate distribution. A portion of thread 52 is also shown in FIGS. 1A and 1B. For opening, unscrewing of the closure causes lugs 44 to move over threads 52, causing retention feature 45 to push upwards against disc curl 32, thereby raising the disc 30 from the container 50.

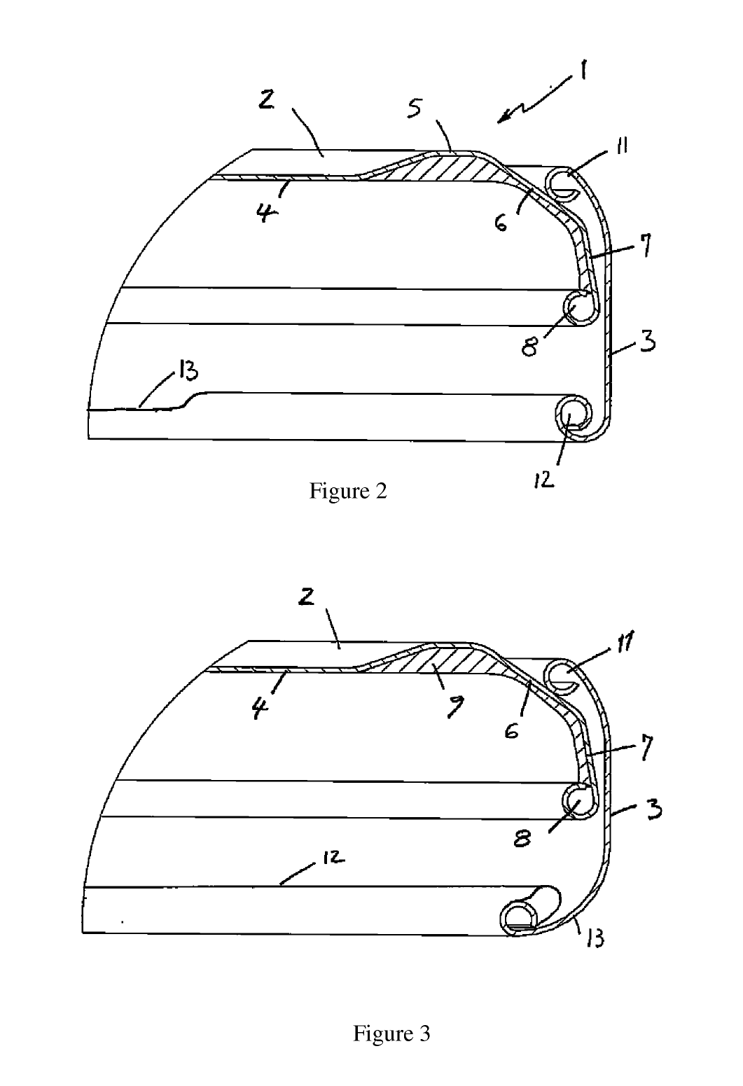

FIGS. 2 and 3 show an all-metal two-part closure 1 having a disc part 2 and a skirt or ring part 3. Disc 2 has a central panel 4, surrounded by upwardly extending groove 5, shoulder 6, annulus 7 and terminating in inward curl 8. The groove 5 is profiled so as to retain sealing material or material 9, in this example from the edge of central panel 4 to the curl 8.

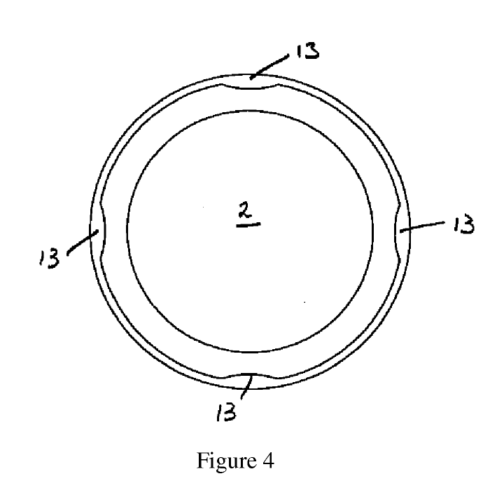

The skirt 3 of FIGS. 2 and 3 has inward curls 11 and 12 at both upper and lower ends and lugs 13 (typically four, equi-spaced) around the lower edge. The lugs 13 are shown most clearly in the underplan view of FIG. 4. The top of the skirt (ring) in FIGS. 2 and 3 is below the level of the top of the channel 5, so that this embodiment is sometimes referred to as “ring below disc” or “disc over ring”.

This ring below disc configuration has a smooth feel. When the closure is used to close a filled container, there is less risk of scuffing of the ring. An alternative ring below disc closure may have the disc panel extending outside the top curl of the ring.

When the container is a glass jar which is closed by the ring below disc closure, it is well suited for stacking. The top of the closure may nest with a stacking bead around the bottom rim of the jar above.

In its form independently of any container, the disc 2 is free to move between a lower position when the curl on the disc abuts curl 12 and/or lug 13, and an upper position, as shown, when the disc abuts curl 11. The shoulder 6 of the disc of FIGS. 2 and 3 contacts upper curl 11. Sealing material 9 could of course be contained more locally by shaping the disc.

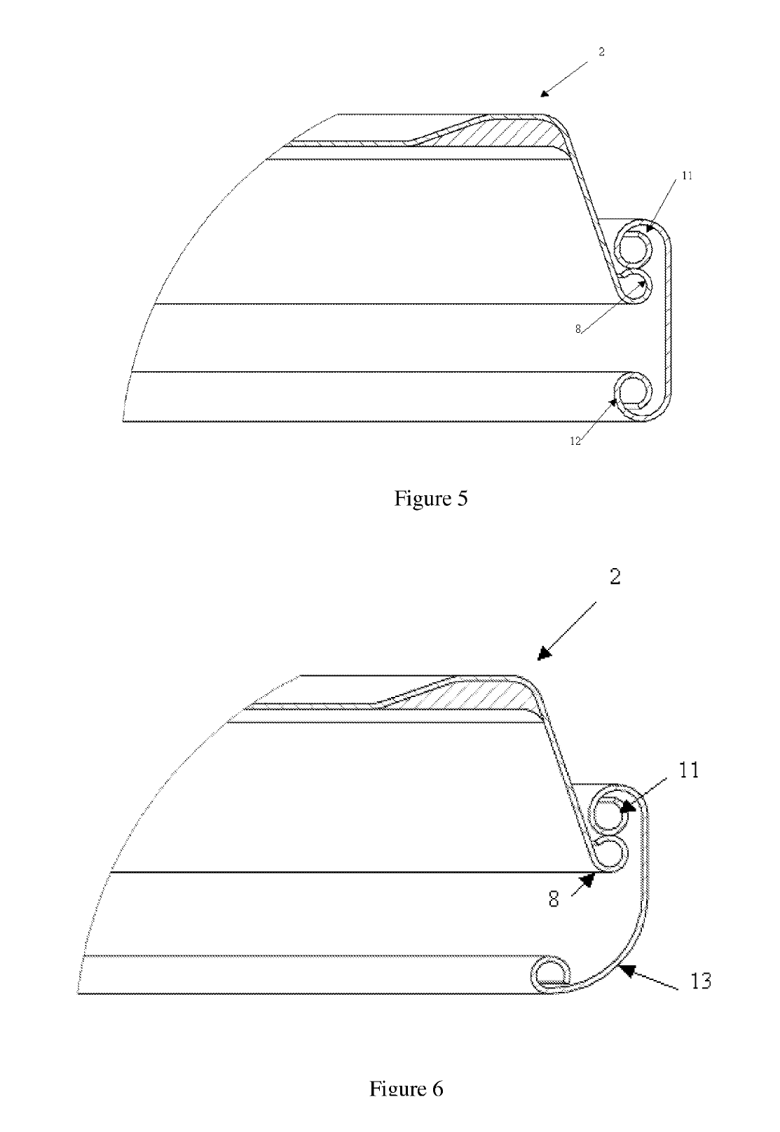

Either curl may be inward or outward (reversed), with the ring above or below the panel. The curls may be partly or fully closed, rest on or in features of the disc 2 or ring 3, or other possible variants. In one arrangement, as shown in FIGS. 5 and 6, the disc curl 8 may be outward and the top curl 11 may be inward, such that the surface of the ring curl 11 that was originally on one side (preferably the decorated side) of the metal sheet contacts the surface of the disc curl 8 that was originally on the other side of the metal sheet. In this arrangement the contacting surfaces may have different coatings or one may not be coated at all, in order to avoid similar coatings sticking to one another, and the possibly undecorated surface of the outside of the disc curl 8 may be hidden from view when looking from the outside of the closure. FIG. 5 shows the inward top curl 11 resting on the outward disc curl 8 at a section through the lower curl 12 and FIG. 6 shows the same closure at a section through the lower lug 13.

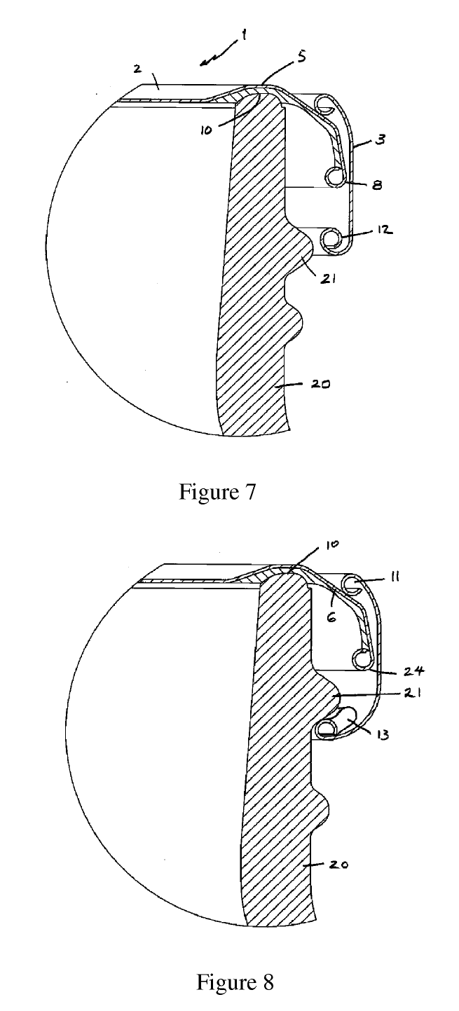

Many features of the closures become more clear when closures are used to close a container. Although any screw container could be closed by any closure according to the invention, the drawings of FIGS. 7 to 10 show a glass jar, which has very distinct threads.

FIGS. 7 and 8 show the closure of FIGS. 2 and 3, closing a glass jar 20. When the closure is applied to a glass jar, the top of the jar presses into sealing material 9 forming an imprint and improved seal 10. The skirt (ring) is rotated and the lug 13 is moved under the thread 21 to pull the disc down.

The relative positions of improved seal 10, underside of disc rim 24 and inwardly projecting lug 13 can be seen in FIG. 8. The seal is defined by that part of the sealing material 9 imprinted by the jar 20.

In the closed position of FIGS. 7 and 8, shoulder 6 presses against upper curl 11 on the skirt, and lugs 13 press against the underside of threads 21. In the closed position of FIG. 8, the lug is under the thread of the glass jar, effectively pulling the disc into place and squeezing the sealing material.

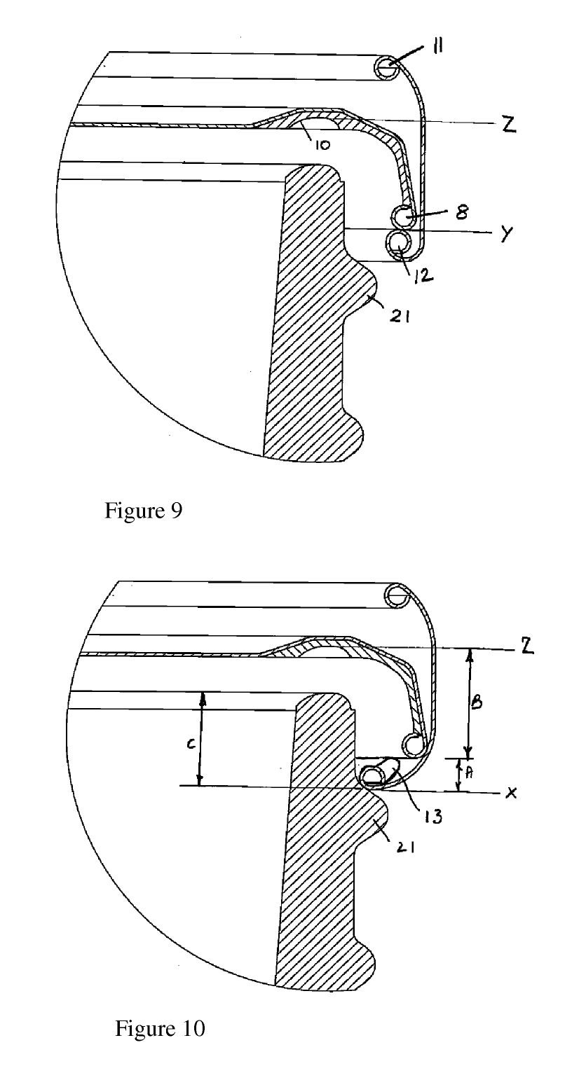

Counter-rotation of the ring causes the lugs to move to positions above the adjacent threads and application of further torque causes lifting of the disc and full opening of the closure (see FIGS. 9 and 10). In the open position, the user has rotated the ring such that the lug 13 is now resting on top of the thread portion 21 (FIG. 10) and the adjacent portion of the bottom curl 12 has moved to contact the bottom of the disc curl 8 (FIG. 9). Moving the curls into contact with each other raises the disc, thereby breaking the seal.

In the final position of FIG. 10, a lug 13 contacts screw thread 21 at position ‘X’. In FIG. 9, the contact point of curls 8 and 12 is shown as ‘Y’. The effective lug thickness, which is the axial distance between X and Y, is distance ‘A’. The axial (vertical) distance from the uppermost part ‘Z’ of compressed material (seal 10) to the bottom of disc curl 8 is ‘B’. The distance from the glass finish (top of the container) to the top of thread 21 is ‘C’.

In order for the seal to be broken, it is necessary for the sum of distances A+B to be greater than distance C.

An alternative version as shown in FIG. 11 has an outward curl 8′. FIG. 11 also shows how the sealing material 9 may be contained more locally by shaping the disc 2 into two parts: an upper annulus or horizontal portion 7a adjacent the shoulder 6 and a depending or vertical portion 7b, which terminates in an outward curl 8′. This is, of course an option which may be used in any of the other embodiments of the invention.

FIG. 11 shows the ring above the level of the top of groove 5 as it is in a “ring over disc” closure.

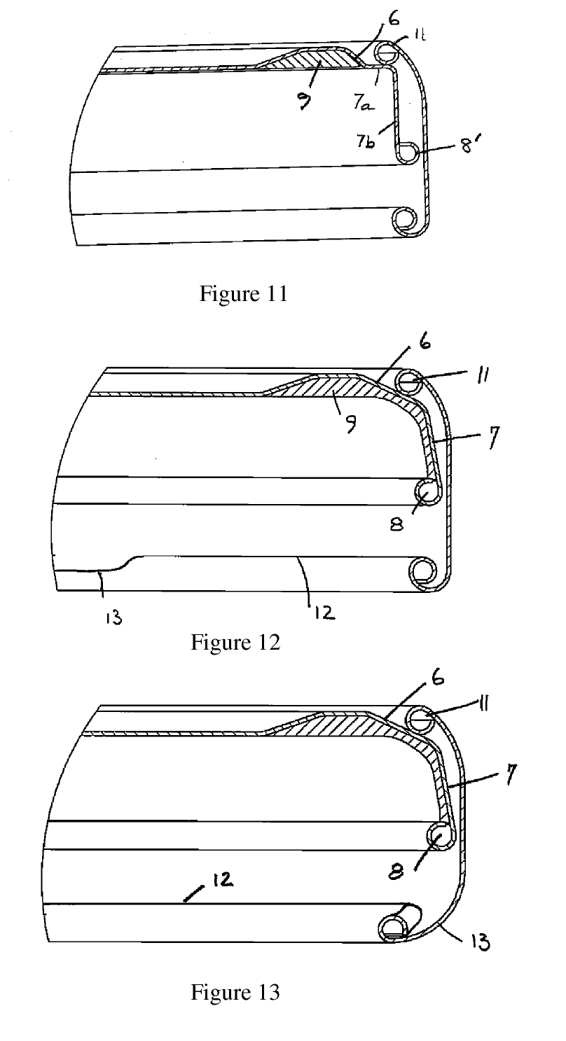

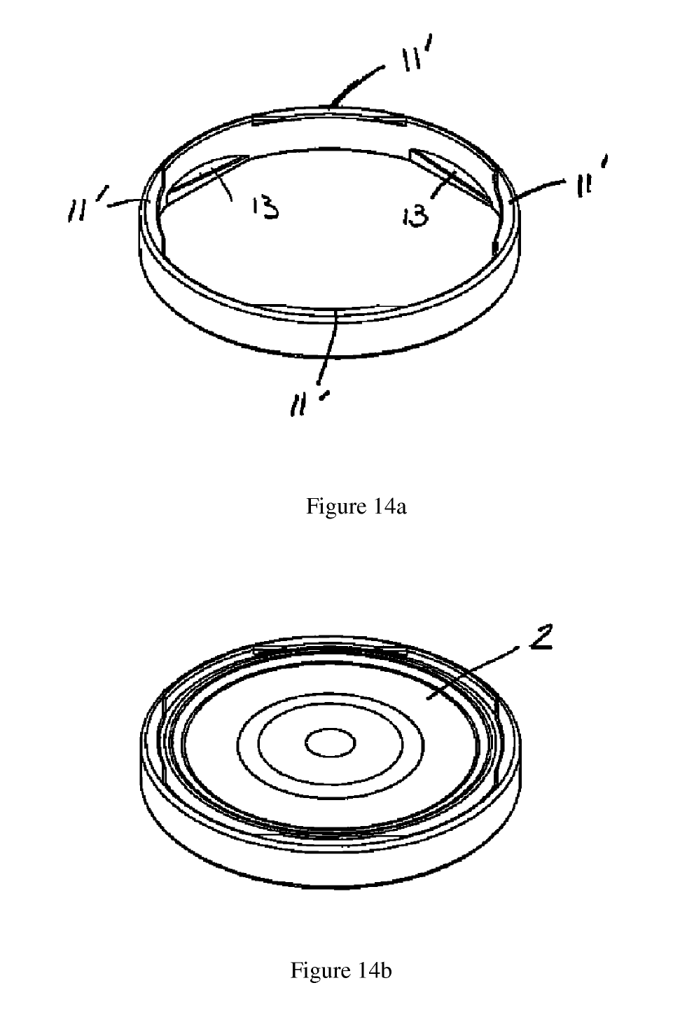

The embodiment of FIGS. 12 and 13, which is also of the “ring over disc” type, has a disc with inward curl 8, inclined shoulder 6 and single part annulus 7. The “ring over disc” closures have uppermost part of disc 3 lower than the top of the skirt, which may assist tightening of the skirt during closing. Over-tightening of the container may be avoided by flexing of the skirt in combination with the disc and at most the skirt will become level with the disc.

It is conventional to provide curls where an exposed edge of cut metal might otherwise be dangerous during handling, to obscure edges for cosmetic purposes, or to protect against corrosion.

Although the embodiments of closure shown in FIGS. 2 to 13 have all metal forms, it is clearly possible to have a metal disc and a plastic skirt. This enables the form shown in FIGS. 14a and 14b to be made more easily, although it could still be made from metal. FIG. 14a shows the skirt 3′ alone. The top projection 11′ is in four parts, with lugs 13 positioned below gaps between projections 11′. If the skirt 3′ is made from plastic, the ejection of the skirt from the mould is easier, as is insertion of the metal disc 2 into the more flexible skirt.

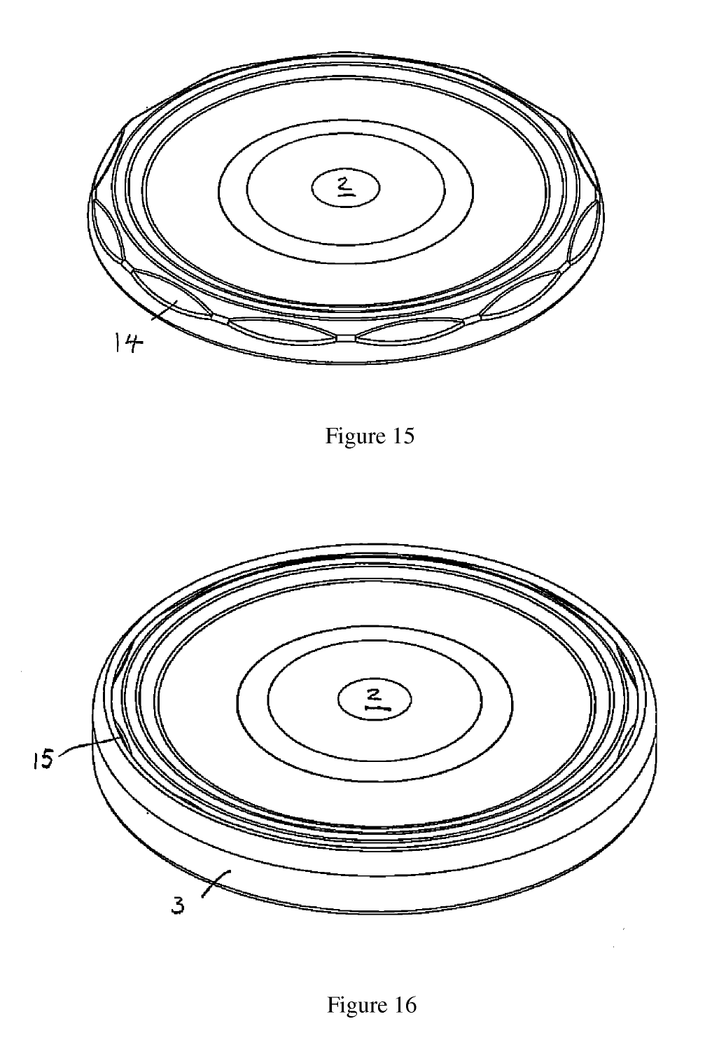

Other features, which the closure may include, are flats or similar undulations 14 around the disc which form gaps 15 when inserted in skirt 3 (FIGS. 15 and 16). This provides a ventilation path and drying of the spaces between the skirt, disc and container is improved after filling.

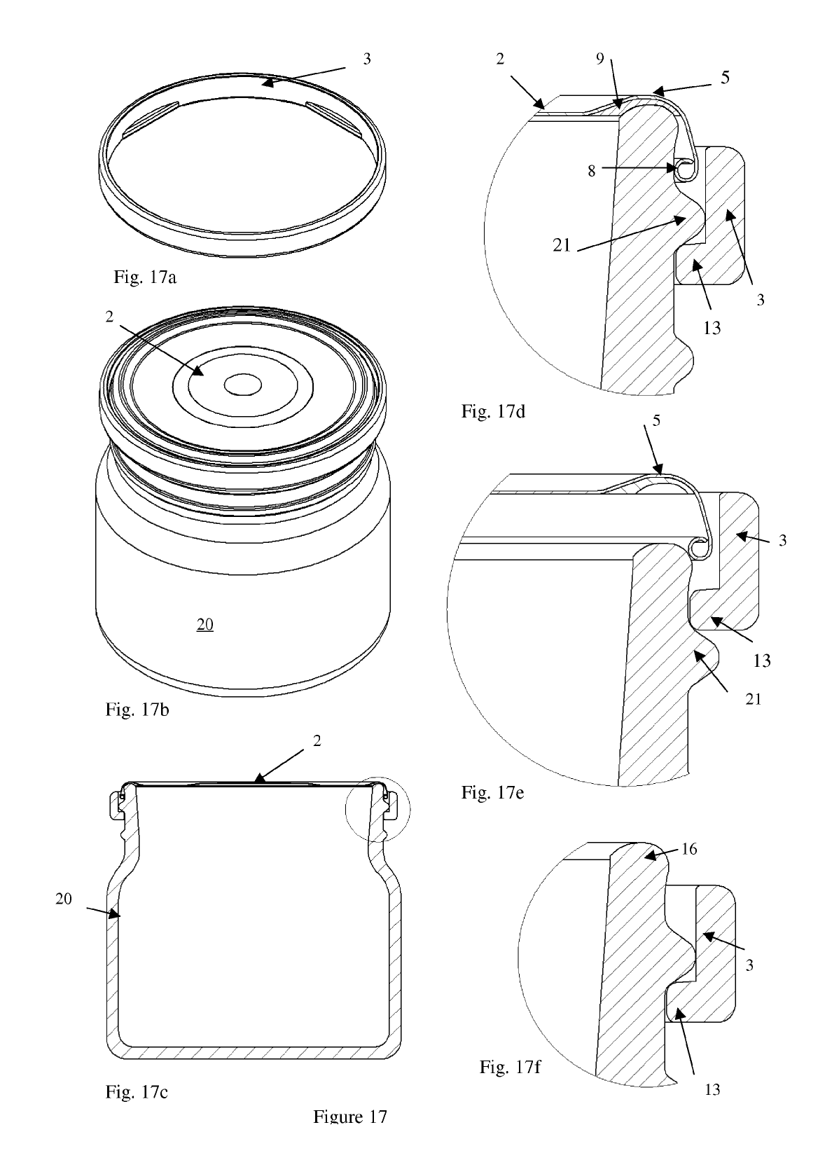

The closure assembly of FIG. 17 is shown in a schematic manner only but is intended to include many of the options of FIGS. 2 to 16. The closure disc of FIG. 17 is adapted to cooperate with the container such as a jar for sealing and does not rely on any upper projection of the ring. It is not necessary to insert the disc within the ring before applying the ring to the threaded container. In fact the ring may be applied, for example by screwing onto the container before closing and may remain on the container even after it has served its function of lifting the disc for opening.

Thus, FIG. 17a shows a ring 3 of plastics material but similar to the plan view of FIG. 4, which has no inwardly projecting upper rim. FIG. 17b shows an assembly of the ring of FIG. 17a with a panel 2 and a jar 20. The upper rim of ring 3 extends substantially vertically without any axial contact, and no or minimal radial, contact with the disc shoulder. This has the effect that the closure assembly can include features of either the “ring over disc” or “ring below disc” types of the earlier embodiments. The choice of ring sidewall height depends purely on whether it is more important to prevent damage or dislodging of the disc or panel 2, in which case the ring 3 will extend axially beyond the disc position, or to avoid scuffing of the ring, in which case the ring sidewall will be lower than the disc 2.

The panel or disc 2 is of metal and has a snap-fit feature such as a curled edge 8 as shown in the sections of FIGS. 17d and 17e. As before, the disc is not simply a thin circular component but includes a profile 5 suitable for containing sealing compound 9 if desired for sealing a container such as glass jar 20. The jar 20 includes a beaded edge 16 over which the curl of the disc/panel 2 may fit (“snap fit”) to assist retention of the panel to the jar when closed. For optimum retention, the curl 8 is curled radially inwardly as shown and the curl is at least 360° so as to avoid corrosion of the exposed cut edge of the metal. An outward curl could still function in the same way but would require further shaping so as to tuck under the bead 21. Of course, this curled edge may include undulations and/or pleats 14 as shown in FIG. 15, which may provide flexibility and assist retention of the panel over the bead. Alternatively, the features 14 can remain outside the sealing surface outside diameter so that sealing is not compromised.

The groove or annulus 5 in the metal disc forms a channel, which is profiled for optimum retention of sealing compound 9 as is also shown in FIGS. 2 and 3. In the embodiment of FIG. 17, the material 9 for sealing may be at least partially pre-formed so as to contact around the sealing surface at the top of the jar. This pre-forming is also of assistance where the sealing is either only obtained by holding under retention bead 16 at the top of the jar, or by whatever additional negative pressure arises when food contents within the jar 20 are processed and “pull” a vacuum. In the absence of any ring feature to pull the disc down further onto the jar, it can be useful for an imprint already to be made in the sealing compound by mechanical means during application of the disc to the jar. What is essential to the embodiment of FIG. 17 is that the disc 2 cooperates with the jar rather than with the ring for primary sealing.

FIG. 17c shows a cross-section of the assembly of FIG. 17b in a closed position, and FIGS. 17d and 17e are detailed views of the cross-section in closed and opened positions respectively. In the closed position of FIG. 17d, projection 13 is below and engaged with screw thread 21. In the open position of FIG. 17e, projection 13 is on top of the thread 21, positioned for “prying-off” (lifting) the disc by contact with curl 8. The ring 3 of FIG. 17 is of plastics material and is shown in a very schematic manner with a simple cylindrical sidewall or skirt and inward projection 13 at its lower end.

Whilst FIG. 17d shows the projection 13 of the ring in a preferred position below the thread of the closed jar, it is not necessary for the projection to be positioned below the thread because the retaining bead 16 and/or the vacuum within the jar may be sufficient to hold the panel 2. The projections or lugs serve the function of lifting the disc 2 from the jar by axial contact with the edge of disc 2 as the ring is moved axially, for example by unscrewing.

As noted above, it is possible firstly to assemble the ring to the jar as is shown for example in FIG. 17f. In this embodiment, the jar has an additional portion of increased diameter 18 to secure and limit the lowermost position of the ring by screwing the ring downwards until the lugs contact portion 18. The portion of increased diameter may be a bead as shown in FIG. 17 or may more simply be a shoulder on the jar. With the ring already assembled to the jar it is possible to simplify the closing of the jar, by simply pushing the panel downwards. This also provides the pre-forming of the sealing compound, if necessary.

The embodiment of FIG. 17 thus includes many of the features of the earlier figures but functions by co-operation of the disc with the jar, for closing, and with the ring, for opening.

As the ring may be of metal or plastics material, a wide range of possibilities present themselves for projection 13. For example, the projection 13 may be inwardly projecting lugs as in the metal ring of FIGS. 6 and 8. Alternatively, the projections can be moulded as in the plastic ring of FIG. 14.

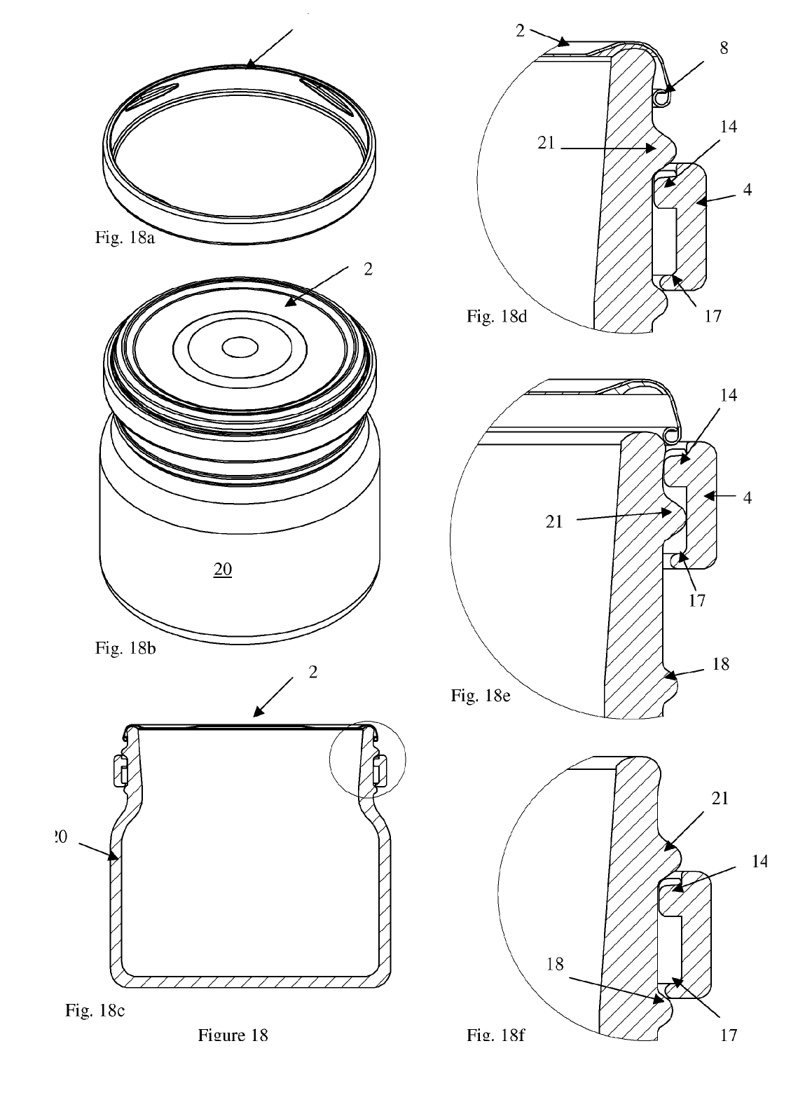

It is also possible for there to be projections both in the form of lugs and also further projections positioned further “up” the sidewall of the skirt as shown in FIG. 18. The latter projections 14 act as the pry-off feature(s) whereas the lug-type of projections 17 allow rotation of the ring up a helical profile on the container sidewall.

The pry-off feature 14 is positioned below the snap-feature of the metal panel and, in use, lug-style projections 17 can serve not only to engage with helical features on the container sidewall but also to pry-off the disc by release of the snap-fit seal.

FIG. 18a shows a ring that has an inwardly projecting lower rim 17, and FIG. 18b is an assembly of that ring with a panel and a jar. FIG. 18c shows a cross-section of the assembly of FIG. 18b in a closed position, and FIGS. 18d and 18e are detailed views of the cross-section in closed and opened positions respectively. As in FIG. 17, the jar has a bead 16 over which the curl on the panel fits to assist retention of the panel to the jar when closed.

In FIG. 18, the jar has an additional portion of increased diameter (here shown as bead 18) which secures and limits the lowermost position of the ring, by screwing the ring downwards until the lower rim 17 contacts the additional portion 18. The bead as shown in FIG. 18 could alternatively and more simply be a shoulder on the container.

Whilst FIG. 18d shows the lug of the ring below the thread of the closed jar, it is not necessary for the lug to be positioned below the thread if the panel is held by the retaining bead and/or the vacuum within the jar. It is also possible firstly to assemble the ring to the jar as is shown in FIG. 18f, by flexing the ring and pushing the lower rim 17 over the jar threads. With the ring already assembled to the jar, closing of the jar can be simplified, by simply pushing the panel downwards.

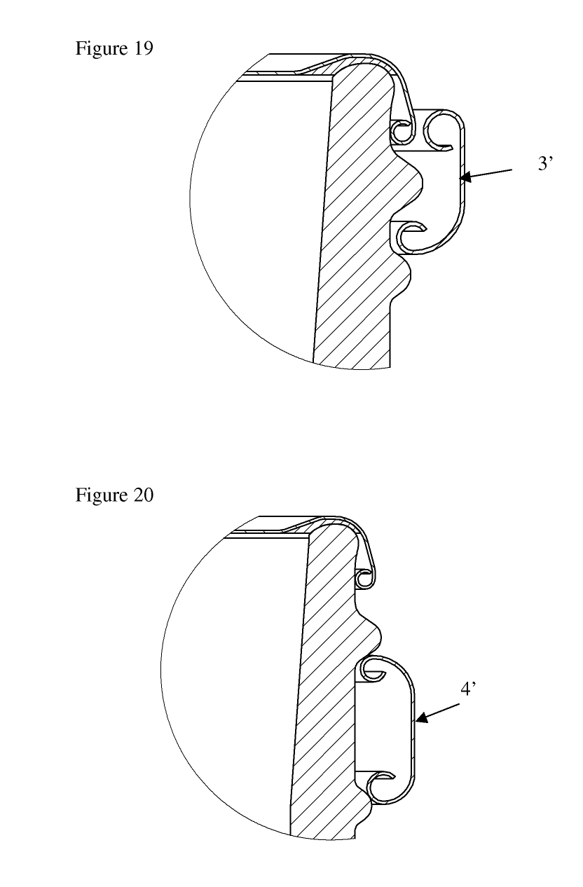

FIGS. 19 and 20 show enlarged cross sections of a top part of a closed jar in which the ring of FIG. 17d has been replaced by a ring 3′ made of thin sheet metal and where the ring of FIG. 18d has been replaced by a ring 4′ made of thin sheet metal, respectively.

Although the invention has predominantly been described with reference to an all-metal closure and a glass jar, the scope of the invention is also intended to include changes and modifications to materials etc and numbers of features such as lugs, as defined by the scope of the claims.

1. A two-part closure comprising:
a metal panel and a ring and being adapted for use with a container for packaging food stuffs,
the ring comprising a radially inwardly extending pry-off structure on a substantially cylindrical side wall; and
the metal panel comprising a center panel, a shoulder and a structure adapted for engaging with the rim of the container to form a seal.

2. A closure according to claim 1, in which the pry-off feature comprises continuous or discontinuous circumferential beads or lugs which engage with helical features on the side wall of the container for rotating of the ring on the sidewall.

3. A closure according to claim 1, in which the pry-off feature on the closure ring or skirt is adapted to release the metal panel or disc by breaking the seal between the panel feature and the container edge.

4. A closure according to claim 1, in which the panel feature comprises a radially inwardly curled edge which co-operates with the rim of the container to form a snap-fit.

5. A closure according to claim 1, in which the sidewall of the ring extends axially and vertically beyond the panel or disc whereby, in use, the panel or disc is protected.

6. A closure according to claim 4, in which the pry-off feature is displaced from the top edge of the ring and from the snap-fit feature of the panel or disc when, in use, the closure is in its closed position on a container.

7. A closure according to claim 1, in which the metal panel comprises DR (double reduced) tinplate or ECCS in the range of 500-600 Nmm-2 and thickness ranging between 0.13 mm and 0.2 mm and the panel feature comprises a curl in the range of 0.4-1.0 mm radius.

8. A closure according to claim 1, in which the ring is either of plastics material or of metal, and the outer surface of the ring is knurled or shaped to assist grip.

9. A closure according to claim 1, in which the ring has an inwardly projecting lower rim.

10. A sub-assembly comprising a ring having a radially inwardly extending pry-off structure on a substantially cylindrical side wall, and an axially and vertically extending upper rim, and the ring is adapted for being assembled to a container or jar.

11. A method of forming a closure assemble comprising:
attaching a ring to a container or jar, the ring having a radially inwardly extending pry-off structure on a substantially cylindrical side wall, and an axially and vertically extending upper rim;
filling the container or jar; and
closing the container or jar with a panel.

12. A method of forming a closure assembly comprising:
attaching a ring to a container or jar to form a sub-assembly, the ring having a radially inwardly extending pry-off structure on a substantially cylindrical side wall, and an axially and vertically extending upper rim, supplying the sub-assembly to a filler for filling the container or jar and closing the container or jar with a panel prior to processing.

13. The closure of claim 1 wherein the structure adapted for engaging with the rim of the container is a snap-fit structure.

14. The method of claim 12, wherein the metal panel and the ring are being adapted for use with a container for packaging food stuffs and the metal panel comprises a center panel, a shoulder and a structure adapted for engaging with the rim of the container to form a seal.

15. The method of claim 12, in which the pry-off feature comprises continuous or discontinuous circumferential beads or lugs which engage with helical features on the side wall of the container for rotating of the ring on the sidewall.

16. The method of claim 12, in which the pry-off feature on the closure ring or skirt is adapted to release the metal panel or disc by breaking the seal between the panel feature and the container edge.

17. The method of claim 12, in which the panel feature comprises a radially inwardly curled edge which co-operates with the rim of the container to form a snap-fit.

18. The method of claim 12, in which the sidewall of the ring extends axially and vertically beyond the panel or disc whereby, in use, the panel or disc is protected.

19. The method of claim 17, in which the pry-off feature is displaced from the top edge of the ring and from the snap-fit feature of the panel or disc when, in use, the closure is in its closed position on a container.

20. The method of claim 12, in which the metal panel comprises DR (double reduced) tinplate or ECCS in the range of 500-600 Nmm-2 and thickness ranging between 0.13 mm and 0.2 mm and the panel feature comprises a curl in the range of 0.4-1.0 mm radius.

21. The method of claim 12, in which the ring is either of plastics material or of metal, and the outer surface of the ring is knurled or shaped to assist grip.

22. The method of claim 12, in which the ring has an inwardly projecting lower rim.

23. The method of claim 12, wherein the structure adapted for engaging with the rim of the container is a snap-fit structure.
